(19) United States
(12) Patent Application Publication
(10) Pub. No.: US 2018/0041246 A1
(43) Pub. Date: Feb. 8, 2018

(54) LINE GROUPING FOR CROSSTALK AVOIDANCE

(71) Applicant: Lantiq Beteiligungs-GmbH & CO.KG, Neubiberg (DE)

(72) Inventors: Rainer Strobel, Munich (DE); Vladimir Oksman, Morganville, NJ (US)

(21) Appl. No.: 15/558,001

(22) PCT Filed: Mar. 31, 2016
(86) PCT No.: PCT/EP2016/057026

§ 371 Date: Sep. 13, 2017

Related U.S. Application Data
(60) Provisional application No. 62/146,995, filed on Apr. 14, 2015.

(51) Int. Cl. H04B 3/32; H04B 10/25; H04B 3/487

(52) U.S. Cl. CPC H04B 3/32; H04B 3/487; H04B 10/2504

(57) ABSTRACT

According to embodiments, crosstalk avoidance in a data transmission system is based on separating lines of the data transmission system at least into a first group, a second group, and a third group. Transmissions on lines of the first group are controlled to occur at different times than transmissions on lines of the second group. Transmissions on lines of the third group are allowed to occur at the same time with transmissions on the lines of the first group or with transmissions on the lines of the second group.

The present application relates to methods for crosstalk avoidance in a data transmission system and to corresponding apparatuses.

### BACKGROUND

Digital Subscriber Line (DSL) technology using copper loops, e.g., including ADSL, ADSL2, (S)HDSL, VDSL, VDSL2, and G.fast, during all its history, attempted to increase the bit rate in the aim to deliver more broadband services to the customer. Since copper loops deployed from a Central Office (CO) to a customer premises equipment (CPE) are typically rather long and do not allow transmission of data with bit rates more than few Mb/s, modern access networks use street cabinets, MDU-cabinets, and similar arrangements, also referred to as distribution points (DP): the cabinet or other DP is connected to the CO by a high-speed fiber communication line, e.g., gigabit passive optical network (GPON) and installed close to the customer premises. From these cabinets, high-speed DSL systems, such as Very-High-Bit-Rate DSL (VDSL), provide connection to the CPE. The currently deployed VDSL systems (ITU-T Recommendation G.993.2) have range of about 1 km, providing bit rates in the range of tens of Mb/s. To increase the bit rate of VDSL systems deployed from the cabinet, the recent ITU-T Recommendation G.993.5 defined vectored transmission that allows increasing upstream and downstream bit rates up to 100 Mb/s. Vectoring is also used in the G.fast technology according to ITU-T Recommendation G.9701.

Recent trends in the access communications market show that data rates up to 100 Mb/s which are provided by VDSL systems using Vectoring as defined in ITU-T Recommendation G.993.5 are not sufficient and bit rates up to 1.0 Gb/s are required, which is possible with the G.fast technology. The G.fast technology achieves very high data rates in the fiber to the distribution point (FTTdp) network topology, where the service is provided from a distribution point which is as close as 50 m-100 m to the customers.

In an intermediate step, the existing street cabinet infrastructure (fiber to the curb, FTTC) used to support data rates up to 100 Mbit/s of vectored VDSL2 (ITU-T Recommendation G.993.5) can be upgraded with installing also G.fast ports (instead or in addition to VDSL2 ports in the aim to proide higher bit rate (hundred of Mb/s) for short reach customers connected to the cabinet. Besides other technology candidates, a long-reach G.fast system gives the most promising results for rate improvements in a FTTC system.

However, while G.fast is designed for small FTTdp nodes with 8 or 16 lines, the FTTC architecture requires crosstalk cancelation for a much higher number of lines (like 100 and more). Computation complexity in terms of operations per second and the size of coefficient memory increases quadratically with the number of lines.

On the other hand, vectored VDSL2 supports a large number of lines for crosstalk cancelation. Partial crosstalk cancelation, where only crosstalk from the strongest disturbers of each line is cancelled, may be used to reduce the computational complexity. However, these partial crosstalk cancelation techniques are not suitable to be reused for G.fast lines. For example, the crosstalk at a majority of G.fast frequencies is much stronger than in vectored VDSL2, and the partial crosstalk cancelation techniques of vectored VDSL2 may be insufficient to keep the required data rates in G.fast deployments.

Further, in systems where the computation capabilities are distributed over multiple DPs or multiple processors within a street cabinet, the data communication between the DPs or processors is an additional limitation.

Accordingly, there is a need for technologies which allow for efficient operation of lines in a data transmission system, e.g., a data transmission system based on G.Fast and/or vectored VDSL2.

### SUMMARY

Devices, methods and systems as defined in the independent claims are provided. The dependent claims define further embodiments.

The above summary is merely intended to give a brief overview over some aspects and features of some embodiments and is not be construed as limiting. Other embodiments may comprise different features, alternative features, less features and/or additional features.

### BRIEF DESCRIPTION OF THE DRAWINGS

FIG. 1 is a block diagram illustrating a data transmission system according to an embodiment.

FIGS. 2A and 2B illustrate exemplary scenarios in which methods according to embodiments may be applied.

FIG. 3 illustrates a system model for a downstream transmission direction as utilized in an embodiment.

FIG. 4 schematically illustrates grouping of lines according to an embodiment.

FIG. 5 schematically illustrates an embodiment involving utilization of a discontinued line for performance enhancement of another line.

FIG. 6 illustrates an example of transmission timing which may be utilized in grouped transmissions according to an embodiment.

FIG. 7 illustrates a further example of transmission timing which may be utilized in grouped transmissions according to an embodiment.

FIG. 8 illustrates an exemplary scenario involving crosstalk avoidance in both the time domain and the frequency domain.

FIG. 9 shows a table for illustrating an example of a startup sequence according to an embodiment.

FIGS. 10 and 11 show results of simulations on a data transmission system utilizing crosstalk avoidance according to an embodiment.

FIG. 12 shows a flowchart illustrating a method of crosstalk avoidance according to an embodiment.

FIG. 13 shows a block diagram for schematically illustrating a device according to an embodiment.

### DETAILED DESCRIPTION

Embodiments will be described in the following in detail with reference to the attached drawings. It should be noted that these embodiments serve as illustrative examples only and are not to be construed as limiting. For example, while embodiments may be described having numerous details, features or elements, in other embodiments some of these details, features or elements may be omitted and/or may be replaced by alternative features or elements. In other embodiments, additionally or alternatively further features, details or elements apart from the ones explicitly described may be provided.

Communication connections discussed in the following may be direct connections or indirect connections, i.e., connections with or without additional intervening elements, as long as the general function of the connection, for example to transmit a certain kind of signal, is preserved. Connections may be wireless connections or wire-based connections unless noted otherwise.

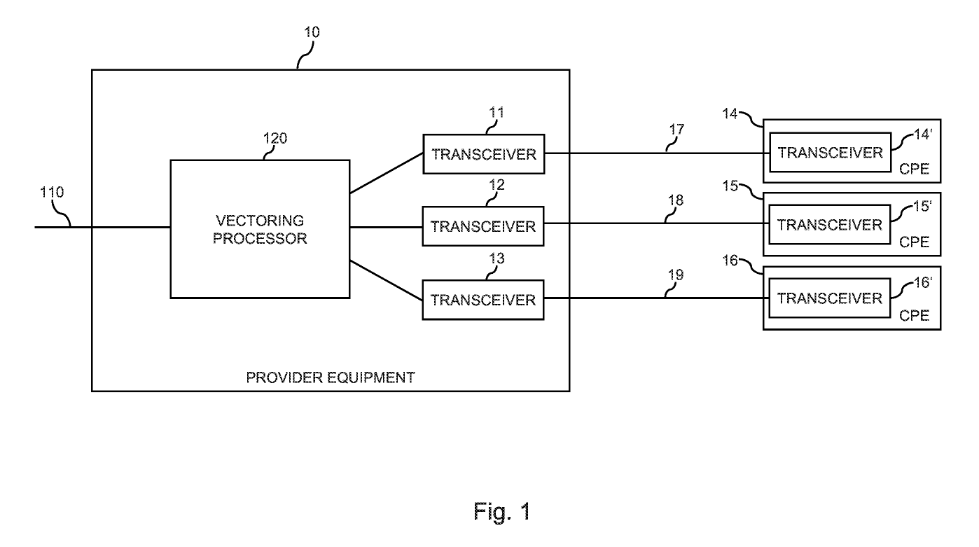

Turning now to the figures, in FIG. 1 a data transmission system according to an embodiment is shown. The system of

FIG. 1 includes a provider equipment 10 communicating with a plurality of CPE units 14-16. While three CPE units 14-16 are shown in FIG. 1, this serves merely as an example, and any number of CPE units may be provided. Some embodiments illustrated below relate to high numbers of CPEs and lines, e.g., numbers in excess of 16, such as 100 or more.

The provider equipment 10 may correspond to a distribution point (DP), e.g., of a FTTdp system. Further, the provider equipment 10 may correspond to street cabinet, e.g., a G.Fast cabinet, of an FTTC system or an FTTB (Fiber to the Building) system. As illustrated, the provider equipment 10 may receive and send data from and to a network via a fiber optic connection 110. In other embodiments, other kinds of connections may be used.

In the embodiment of FIG. 1, provider equipment 10 comprises a plurality of transceivers 11-13 to communicate with CPE units 14-16 via respective communication connections 17-19. In each of the CPE units 14, 15, 16, a corresponding transceiver 14′, 15′, 16′ is provided to communicate via the respective communication connection 14-16. Communication connections 17-19 may for example be copper lines, e.g. twisted pairs of copper lines. Communication via communication connections 17-19 may be communication based on a multicarrier modulation like discrete multitone modulation (DMT) and/or orthogonal frequency division multiplexing (OFDM), for example an xDSL communication like ADSL, VDSL, VDSL2, G.Fast etc., i.e., communication where data is modulated on a plurality of carriers, also referred to as tones. In some embodiments, the communication system may use vectoring. The vectoring may be performed by a vectoring processor, as indicated by a block 120 in FIG. 1. Vectoring comprises joint processing of signals to be sent and/or received to reduce crosstalk.

A communication direction from provider equipment 10 to CPE units 14-16 is herein also referred to as downstream (DS) direction, and a communication direction from CPE units 14-16 is herein also referred to as upstream (US) direction. Vectoring in the downstream direction is also referred to as crosstalk pre-compensation, whereas vectoring in the upstream direction is also referred to as crosstalk cancelation or equalization.

Provider equipment 10 and/or CPE units 14-16 may include further communication circuits (not shown) conventionally employed in data transmission systems, for example circuitry for modulating, bit loading, Fourier transformation, or the like.

In the illustrated embodiments, communication via communication connections 17-19 may be frame-based. A plurality of frames may form a superframe. The frames may be based on time division duplex (TDD), in particular synchronized time division duplex (STDD), such as used in DP vectored transceivers, e.g., based on the G.fast technology.

According to embodiments as described in the following, methods are provided which may be used to increase the reach of the G.fast technology, e.g., to overcome a current reach limitation of 400 m and support sufficiently high bit rate on line lengths of more than 400 m. Accordingly, the methods may be used to improve the data rates of the long lines, i.e., of the lines above 400 m length, so that they can offer a competitive service for subscribers.

In embodiments as described herein, it is utilized that G.fast allows an additional degree of freedom which may be utilized in (partial) crosstalk cancelation. In particular, lines can discontinue data transmission to save power. The idea of discontinuous operation can be used to avoid crosstalk. This “grouping based crosstalk cancelation” reduces the complexity of crosstalk cancelation. Specifically, multiple groups of lines may be formed which do never transmit simultaneously. For example, all lines may be divided into a number of smaller vectored groups, which operate in a mutual crosstalk avoidance mode, while some long lines are part of all vectored groups, such that they may transmit at all available times during the transmission frame.

In the illustrated embodiments, small vectored groups (i.e., groups which are smaller than the total number of lines in the data transmission system) may be used. This reduces the complexity of the vectoring computation. The grouping based crosstalk cancelation may be used as a replacement for or in addition to partial crosstalk cancelation, where some of the crosstalk couplings are not canceled. Both methods can be combined to have the best possible trade-off between performance and complexity.

In the illustrated embodiments, strong crosstalk couplings in G.fast be used to increase performance of longer lines. Transmit power allocation can be performed such that a weighted sum-data rate is maximized. The transmit power may be allocated in such a way that the long lines have higher weights than the short lines. This increases the received signal strength for long lines. This is one way to improve long loops by spectrum management.

Another way to improve performance of long lines is based on the discontinuous operation groups. This may work as follows: In the data transmission system, there may be shorter lines which do not require the complete transmission time to achieve their target rates. These lines are put into different vectored groups, which do not transmit simultaneously. But the long lines, where the data rate shall be improved, are part of all these groups and transmit continuously.

Furthermore, this setup reduces the group of simultaneously transmitting lines in comparison to the full vectoring group. This may increase the performance of long lines because of reduced residual crosstalk and relaxed channel conditions.

According to an embodiment, precoder outputs of discontinued lines remain enabled all time, such that the transmitters of the discontinued lines can be used to enhance the signals of the active lines via crosstalk.

According to a further embodiment, the discontinued lines are switched off by shutting down the corresponding line driver and analog front-end, such that more power saving is possible.

In embodiments as further detailed below, the data transmission system may include one or more street cabinets which are provided with G.fast technology. Such street cabinet will herein also referred to as “G.fast cabinet”. The street cabinets may be connected to a back-end of an access network via fiber optic connections, e.g., in an FTTC or FTTB topology.

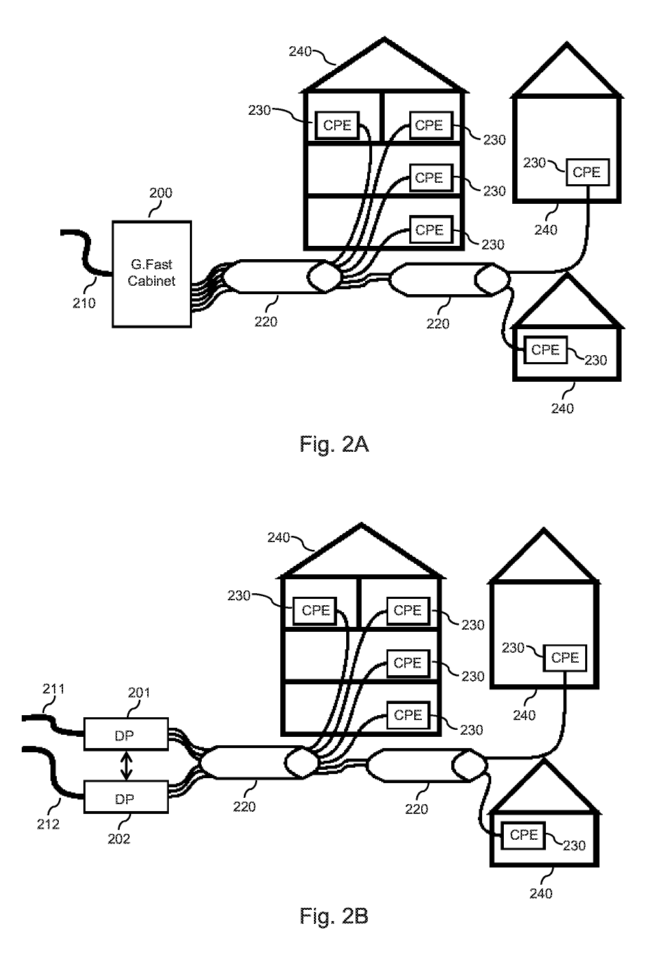

FIG. 2A shows an example of a FTTC or FTTB topology with a street cabinet 200, e.g., a G.fast cabinet. As illustrated, in this case the data transmission system includes the street cabinet 200, which is connected by a fiber optic connection 210 to the back-end of the access network, bundles (or binders) of twisted pair lines 220, and a plurality of CPEs 230 located in buildings 240. The twisted pair lines 220 connect the CPEs 230 to the street cabinet 200.

FIG. 2B shows a further topology with coupled distribution points (DPs) 201, 202. Each of the DPs 201, 202 may be based on the G.Fast technology. As illustrated, in this case the data transmission system includes the DPs 201, 202, which are each connected by a corresponding fiber optic connection 211, 212 to the back-end of the access network, bundles (or binders) of twisted pair lines 220, and a plurality of CPEs 230 located in buildings 240. The twisted pair lines 220 connect the CPEs 230 to the DPs 201, 202. In the topology of FIG. 2B, the DPs 201, 202 are coupled to each other to enable crosstalk cancelation or avoidance also between lines connected to different DPs 201, 202. For this purpose, the DPs 201, 202 may exchange disturber data. On the basis of the exchanged disturber data, the DPs 201, 202 may then perform crosstalk cancelation.

Further scenarios in which the illustrated concepts may be applied include large DPs of an FTTdp or FTTB system in larger buildings. Further, multiple DPs may be coupled by a high speed interface to support a larger number of subscribers with FTTdp and synchronize the DP systems.

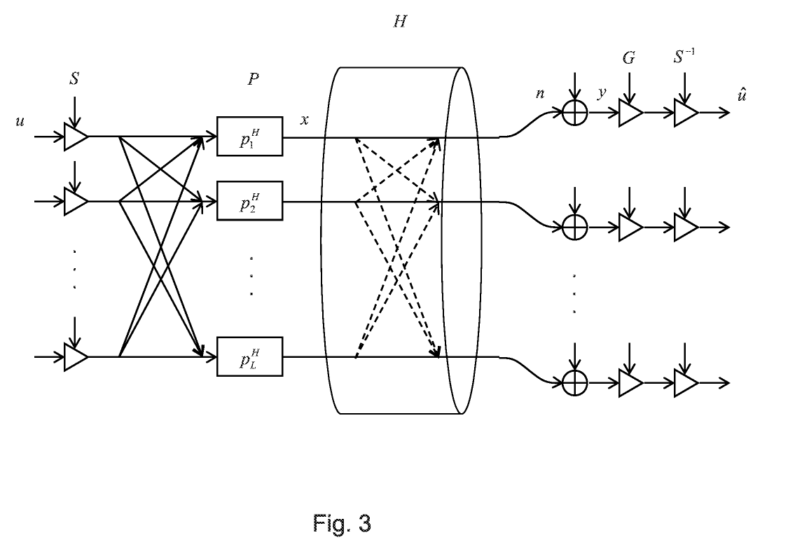

FIG. 3 schematically illustrates a transmission model for the data transmission system. A multi-carrier transmission system, using DMT or OFDM modulation is assumed. The data transmission system uses carriers k=1, . . . , K. Data transmission is performed over a MIMO (Multiple Input Multiple Output) channel with multiple transmitters and joined transmit signal processing for downstream direction and joined receive signal processing in upstream direction.

The illustrated model refers to linear precoding and linear equalization, but may also be applied to nonlinear precoding and equalization. The transmit power scaling is performed per line and per subcarrier. The transmission is described by

ũ=S^{(k)}^{^{−1}}G^{(k)}(H^{(k)}P^{(k)}S^{(k)}u^{(k)}+n^{(k)}) (1)

where u^{(k)} is the transmit signal which is scaled by the diagonal real positive-valued matrix S^{(k)} to satisfy the transmit power constraints. A linear precoder matrix P^{(k)} is used to perform crosstalk pre-compensation in downstream. For non-linear precoding, this may be replaced by the corresponding nonlinear operation. The transmit signals are transmitted over the crosstalk channel H^{(k)} and receive a noise n^{(k)} at the receivers (CPEs). They do equalization with the diagonal matrix G^{(k)}=diag([g₁^{(k)}, . . . , g_{L}^{(k)}]) and compensate the signal scaling S^{(k)} to get the receive signal û^{(k)}.

STDD may be used to separate upstream and downstream direction and to avoid near-end crosstalk. Far-end crosstalk may be mitigated using linear (or nonlinear) precoding in downstream direction and equalization in upstream direction. The data transmission system is assumed supports discontinuous operation where transmit signals are switched off on a per-DMT symbol basis.

In the following, concepts of complexity limited vectoring will be explained in more detail. Two measures of complexity may be considered to be important for the system design of a G.fast system with crosstalk cancelation. The considerations are typically based on the cost and power consumption of integrated circuits which are used to perform the signal processing tasks. The first measure is the compute complexity M_{C}, e.g., in terms of operations per second. The compute complexity for example defines a number of processors and speed of processors required in the system. The second complexity measure is the memory size M_{M}, e.g., in terms of bytes, which is required to store coefficients. It defines the size of the integrated memories, which in turn drive the cost of integrated circuits.

According to embodiments illustrated herein, two methods may be used to reduce the required memory size M_{M} and the compute complexity M_{C}. One method is partial crosstalk cancelation, where parts of the crosstalk canceler matrix are set to zero and do not require memory or compute resources.

The second method is crosstalk avoidance by discontinuous operation, where some lines do not transmit for a certain time. Then, they do not cause crosstalk and do not require crosstalk cancelation, which saves computational resources and reduces compute complexity M_{C}.

Furthermore, if the lines are split into different groups of lines where some of them do never transmit at the same time, no canceler coefficient is required between these lines, which typically saves memory and thus reduces the required memory size M_{M}.

According to embodiments as illustrated herein, both methods may be combined with the aim of achieving the best possible performance with respect to the given complexity limitations.

In the following, the method of partial crosstalk cancelation will be explained in more detail. For this purpose, the method of partial crosstalk cancelation is demonstrated with a linear precoder matrix P. However, it is to be understood that similar considerations also apply in the case of a non-linear precoder matrix. Assuming first a scenario without partial crosstalk cancelation, there is a full precoder matrix

$${P}^{( k )} = ( \begin{matrix}1 & {p}_{12}^{( k )} & {p}_{12}^{( k )} \\ {p}_{21}^{( k )} & 1 & {p}_{23}^{k} \\ {p}_{31}^{( k )} & {p}_{32}^{( k )} & 1\end{matrix} ) , \qquad ( 2 )$$

The partial crosstalk cancelation method uses a selection matrix P_{pc} with elements p_{pc ij}∈{0,1} which are either 1 for crosstalk couplings j→i which are compensated, or 0 for couplings j→i which are ignored because they are weak. The diagonal elements p_{pc ii} are always equal to 1 for lines which are enabled. Usually, it is sufficient to have one selection matrix P_{pc} which holds for all carriers, because the relative strength of crosstalk couplings does not change much over frequency. The partial cancelation precoder matrix is then

$${P}^{( k )} ⊙ {P}_{pc} = ( \begin{matrix}1 & {p}_{12}^{( k )} & 0 \\ {p}_{21}^{( k )} & 1 & {p}_{23}^{k} \\ 0 & 0 & 1\end{matrix} ) \qquad ( 3 )$$

for a selection matrix

$${P}_{pc} = ( \begin{matrix}1 & 1 & 0 \\ 1 & 1 & 1 \\ 0 & 0 & 1\end{matrix} ) , \qquad ( 4 )$$

where ⊙ denotes the Hadamard product, i.e., the element-wise product of the matrices.

The complexity of full cancelation for a system with L lines, K carriers and a DMT symbol time t_{sym} and linear precoding may be represented as

$${M}_{c full} = \frac{{L}^{2} K}{{t}_{sym}} . \qquad ( 5 )$$

The operations are complex multiply-accumulate operations. With partial crosstalk cancelation, only the nonzero elements M_{pc}=Σₘ₌₁^{L}Σₙ₌₁^{L}p_{pc mn} of the selection matrix P_{pc} are counted. The compute complexity then becomes

$${M}_{c full} = \frac{{M}_{pc} K}{{t}_{sym}} . \qquad ( 6 )$$

This includes the diagonal scaling coefficients S^{(k)}, which are also part of the precoding operation.

Assuming that each coefficient is stored with b_{c} bits, the memory requirement for the precoding operation with full cancelation is

M_{m full}=L²Kb_{c}. (7)

For partial cancelation, the memory requirement becomes

M_{m partial}=M_{pc}Kb_{c}. (8)

To reduce the memory requirement and compute complexity by a factor 2, the of the disturbers of each victim line can be canceled. To minimize the performance drop due to partial cancelation for longer lines, it is possible to cancel more disturbers on the long lines and less disturbers on the short lines. But the method may cause a significant performance drop when not all of the strong crosstalk couplings can be canceled. Therefore, in embodiments illustrated herein some of the crosstalk may also be reduced by crosstalk avoidance by discontinuous operation.

To reduce the memory requirement and compute complexity with the method of crosstalk avoidance by discontinuous operation, the lines may be separated into two orthogonal groups [symbol] ₁, [symbol] ₂. The group [symbol] ₁ transmits for a time t₁, and the group [symbol] ₂ transmits for a time t₂, which does not overlap with the time t₁.

In the following, the method of crosstalk avoidance by discontinuous operation will be explained as applied to the precoder matrix P, i.e., for the downstream direction. However, it is noted that the same concepts may also be applied to the equalizer matrix G used in the upstream direction.

One requirement on the complexity reduction method, i.e., one constraint of the method of crosstalk avoidance by discontinuous operation, is the aim of not adversely affecting performance on the long lines. This may be achieved by making the long lines part of both groups, [symbol] ₁ and [symbol] ₂. One way to construct the groups is to use a number Nₛ₁ of short lines in the group together with Nₗ long lines in the first group [symbol] ₁ and a number Nₛ₂ of remaining short lines together with the Nₗ long lines in the second group [symbol] ₁. By way of example, a line with length of not more than 400 m may be considered as a short line, and a line with length in excess of 400 m may be considered as a long line. However, it is noted that also other limits could be applied for distinguishing between short lines and long lines, e.g., a limit of less than 400 m, such as 300 m or 250, or a limit of more than 400 m, such as 500 m or 600 m.

The full precoder matrix for discontinuous operation with the two groups may be represented as

$${P}^{( k )} = ( \begin{matrix}{P}_{s 1} & 0 & {P}_{s 1 ← l} \\ 0 & {P}_{s 2} & {P}_{s 2 ← l} \\ {P}_{l ← s 1} & {P}_{l ← s 2} & {P}_{l}\end{matrix} ) , \qquad ( 9 )$$

with a part Pₛ₁ of the matrix to cancel crosstalk within the first group s1 of short lines, a part Pₛ₂ of the matrix to cancel crosstalk within the second group s2 of short lines, a part Pₗ of the matrix to cancel crosstalk within the group of long lines, as well as a parts P_{s1←l}, P_{s2←l}, P_{l←s1}, P_{l←s2} of the matrix to cancel crosstalk between the group of long lines and the corresponding groups s1, s2 of short lines. Crosstalk from the long lines into the short lines is considered by the parts P_{s1←l} and P_{s2←l}, and crosstalk from the short lines into the long lines is considered by the parts P_{l←s1} and P_{l←s2}. Crosstalk between the two groups of short lines, s1 and s2, is not canceled, which contributes to saving memory.

During the time intervals t1 and t2, different parts of the matrix given by (9) are active, i.e., the matrix has a first form Pₜ₁^{(k)} during the time interval t1 and a second form Pₜ₂^{(k)} during the second time interval t2:

$${P}_{t 1}^{( k )} = ( \begin{matrix}{P}_{s 1} & 0 & {P}_{s 1 ← l} \\ 0 & 0 & {P}_{s 2 ← l} \\ {P}_{l ← s 1} & 0 & {P}_{l}\end{matrix} ) \\ and \\ {P}_{t 2}^{( k )} = ( \begin{matrix}0 & 0 & {P}_{s 1 ← l} \\ 0 & {P}_{s 2} & {P}_{s 2 ← l} \\ 0 & {P}_{l ← s 2} & {P}_{l}\end{matrix} ) . \qquad ( 10 )$$

Accordingly, the compute complexity of this scheme may be represented as

$${M}_{c do} = \frac{L ( max ( {N}_{S 1} , {N}_{S 2} ) + {N}_{l} ) K}{{t}_{sym}} , \qquad ( 11 )$$

while the memory requirement may be represented as

M_{m do}=(L²−2Nₛ₁Nₛ₂)Kb_{c}. (12)

In the illustrated method of crosstalk avoidance by discontinuous operation, the output ports of all lines may remain active during all time.

Alternatively, the output ports which correspond to the discontinued lines may also be switched off. Two coefficient sets may then be used for the two groups [symbol] ₁, [symbol] ₂:

$${P}_{t 1}^{( k )} = ( \begin{matrix}{P}_{s 1} & 0 & {P}_{s 1 ← l} \\ 0 & 0 & 0 \\ {P}_{l ← s 1} & 0 & {P}_{l}\end{matrix} ) \\ and \\ {P}_{t 2}^{( k )} = ( \begin{matrix}0 & 0 & 0 \\ 0 & {P}_{s 2} & {P}_{s 2 ← l} \\ 0 & {P}_{l ← s 2} & {P}_{l}\end{matrix} ) . \qquad ( 13 )$$

This allows for switching off the analog front-end components of the output ports of the discontinued lines and thus saving power. The compute complexity may then be represented as

$${M}_{c do 2} = \frac{max ( {( {N}_{S 1} + {N}_{l} )}^{2} , {( {N}_{s 2} + {N}_{l} )}^{2} ) K}{{t}_{sym}} , \qquad ( 14 )$$

which is less than given by (11) for the above-mentioned first scheme of crosstalk avoidance by discontinuous operation. However, additional memory for two independent coefficient sets may then be required. The memory requirement may in this case be represented as

M_{m do2}=((Nₛ₁+Nₗ)²+(Nₛ₂+Nₗ)²−Nₛ₁²)Kb_{c}, (15)

which may be more than given by (12) for the above-mentioned first scheme of crosstalk avoidance by discontinuous operation.

According to some embodiments, the method of crosstalk avoidance by discontinuous operation and the method of partial crosstalk cancelation may also be combined.

In such a combination of both methods, the two groups may be set up in the same way as described for the method of crosstalk avoidance by discontinuous operation, but only M_{pc} victim-disturber pairs are canceled within each of the time intervals t1, t2. Again, only the strongest couplings may be selected for crosstalk cancelation, and for the long lines, more crosstalk may be canceled than for the short lines.

The compute complexity may then be represented as

$${M}_{c do partial} = \frac{min ( L ( max ( {N}_{s 1} , {N}_{s 2} ) + {N}_{l} ) , {M}_{pc} ) K}{{t}_{sym}} , \qquad ( 16 )$$

and the memory consumption may be represented as

M_{m do partial}=(min(L²−2Nₛ₁Nₛ₂,M_{pc}))Kb_{c}. (17)

Furthermore, it should be noted that the value of M_{pc} canceled crosstalk couplings can be selected to be smaller than for the partial cancelation only scheme to achieve the same performance. This may provide additional savings to reduce the compute complexity and memory requirement in a scalable way.

In some embodiments, also certain bandwidth limitations may be considered. For example, in the system of FIG. 2B, but also an integrated G.fast system, which is internally built with multiple communicating processors or other components may be subject to an additional limitation. The bandwidth between the components, e.g., between the DPs 201 and 202, may be limited so that it may not be capable to exchange all disturber data from one processor to the other. In this case, it may be beneficial to distinguish between local and remote disturbers. For the local disturbers, complete crosstalk cancelation may be performed, while for the remote disturbers only a part of the crosstalk could be canceled. This can involve only partially cancelling the crosstalk from given remote disturber and/or cancelling the crosstalk only for a part of the remote disturbers.

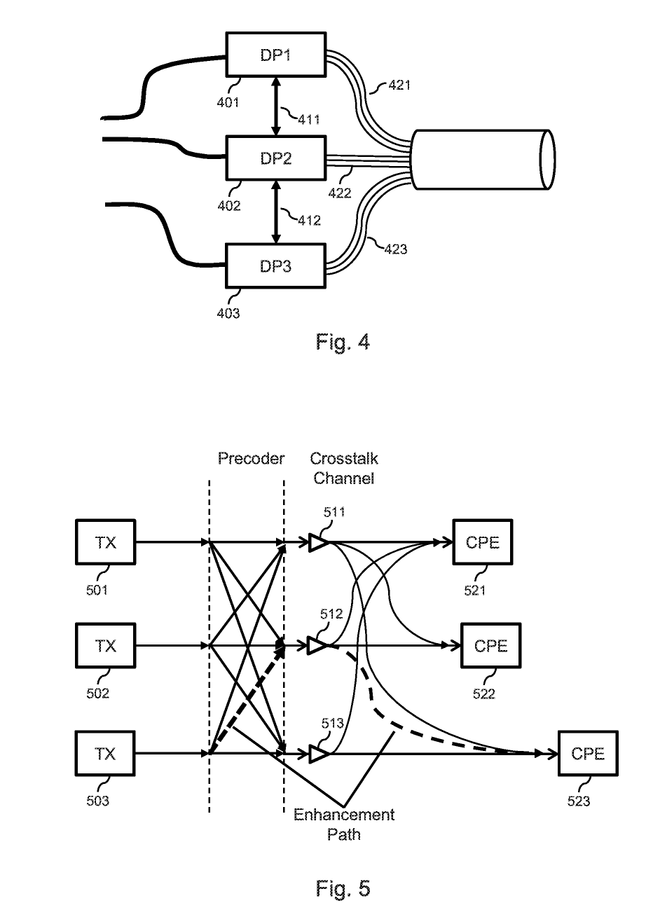

According to an embodiment, the lines are connected to the processors (which may be placed in different DPs) such that they form the groups of long and short lines. A corresponding scenario is shown in FIG. 4. The example of FIG. 4 assumes three processors (or DPs) 401, 402, 403 which are coupled to each other to exchange disturber data. This is accomplished via interfaces 411, 422. The DP 402 is connected via the interface 411 to the DP 401 and via the interface 412 to the DP 403. The DP 401 is connected to lines 421, the DP 402 is connected to lines 422, the DP 403 is connected to lines 423. The lines 422 are assumed to be long lines which require more bandwidth on the interfaces 411, 412, as they require canceling more disturbers from other lines. The lines 421 and the lines 423 are assumed to be short lines and form a first and a second group of short lines, e.g., corresponding to the above-mentioned groups s1, s2.

The interface 421 transports disturber signals of the first group of short lines in one direction (to the DP 402) and disturber signals of the long lines in the other direction (to the DP 401). In a similar way, the interface 422 transports disturber signals of the second group of short lines in one direction (to the DP 402) and disturber signals of the long lines in the other direction (to the DP 403). Disturber data may also be exchanged between the DP 401 and the DP 403 (e.g., indirectly via the DP 402 and the interfaces 421 and 422). However, in some embodiments this exchange may be very limited or even totally absent. The DPs 401, 402, 403 may be placed close to each other or they may be part of a street cabinet or a similar device.

In other embodiments, it might not be possible to arrange the lines in the way as explained in connection with FIG. 4. Rather, the lines may be arbitrarily connected to the DPs or the processors within a street cabinet.

In some embodiments, spectrum management may be used to optimize the weighted sum-rate of the data transmission system. In the optimization process, a higher weight may be assigned to the longer lines, such that their achievable data rates improve.

The above-mentioned crosstalk avoidance method with two sets of coefficients may allow for a further improvement of the long lines by spectrum management. An example of a corresponding scenario is shown in FIG. 5. By way of example, the scenario of FIG. 5 involves a first transmitter (TX) 501 and a first CPE 521 connected by a first line (e.g. a short line), a second transmitter (TX) 502 and a second CPE 522 connected by a second line (e.g., a short line), and a third transmitter (TX) 503 and a third CPE 523 connected by a third line (e.g., a long line). In the scenario of FIG. 5, the transmit signal of the second line is assumed to be switched off, i.e., the line extending from the second transmitter is discontinued. However, the corresponding transmitter 502 and crosstalk canceler coefficients from the active lines to the discontinued line are still enabled. In this way, an enhancement path (shown by dashed arrows) may be formed which extends indirectly from the transmitter 503 to the receiver of the third line (in the CPE 523), via the amplifier 502 of the discontinued line. This enhancement path can be used to increase the receive signal power of the third line.

The above-mentioned spectrum enhancement is particularly beneficial for long lines and may be implemented by providing two bit loading and gain tables for the long lines, one bit and gain table for the part of the TDD frame where they transmit together with the first group of short lines and one for the time when they transmit together with the second group of short lines.

It is noted that scenarios involving more than two groups of short lines are possible as well. In case the number of groups is bigger than two, the number of bit loading and gain tables to support may be increased in a corresponding manner.

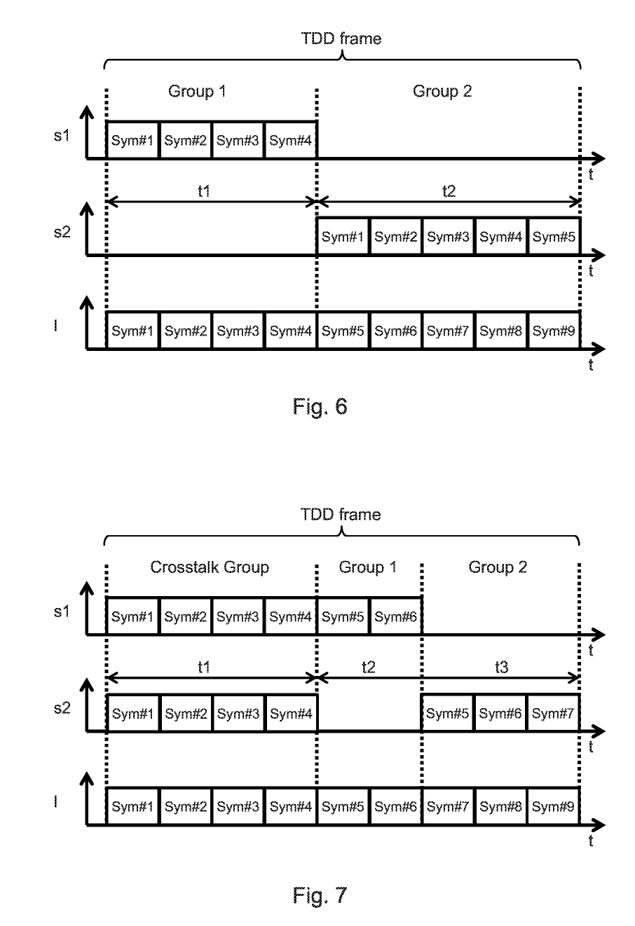

FIG. 6 shows an exemplary timing of transmissions when utilizing the above-mentioned crosstalk avoidance by discontinuous operation and/or partial cancelation. Specifically, FIG. 6 shows the timing of transmissions of data symbols (denoted by “Sym#X”) within a TDD frame. In FIG. 6, each time (t) axis represents a group of lines (a first group of short lines s1, a second group of short lines s2, and a group of long lines l). However, it is noted that there could also be more groups of short lines. As illustrated, the group of long lines transmits continuously, while the groups of short lines perform crosstalk avoidance against each other, because they do not transmit simultaneously. Specifically, the first group of short lines s1 transmits in time interval t1, while the second group of short lines s2 is discontinued in time interval t1. Similarly, the second group of short lines s2 transmits in time interval t2, while the first group of short lines s1 is discontinued in time interval t2.

Each of the lines may have a certain granted data rate R_{min l}. The data transmission system should thus be able to serve the granted data rates when all lines are enabled and request the full data rate. There may be a certain setting for the times t1 and t2 where the granted data rates are satisfied for all lines.

In case that none (or not all) of the lines of one group request the full data rate, there are some free time resources for the other group. In this case, the time settings t1 and t2 can be changed to allow increased peak data rates for the short lines. By constructing more than two groups, the granted data rates of the short lines may be reduced, but the peak data rates and the probability to achieve the peak data rates may increase.

In some embodiments with lower crosstalk, the sustained data rates of the short lines might be higher if both groups of short lines transmit simultaneously, but the crosstalk between them is not canceled. An example of a corresponding scenario is shown in FIG. 7. In the scenario of FIG. 7, a crosstalk group is formed by the groups s1 and s2 during the time interval t1. In the crosstalk group, no cancelation of crosstalk is performed between the groups s1 and s2. During time intervals t2 and t3, the groups of short lines perform crosstalk avoidance against each other. Specifically, the first group of short lines s1 transmits in time interval t2, while the second group of short lines s2 is discontinued in time interval t2. Similarly, the second group of short lines s2 transmits in time interval t3, while the first group of short lines s1 is discontinued in time interval t3.

In the scenario of FIG. 7, the peak rates may still be higher in the crosstalk avoidance times, i.e., during t2 and t3, than in the crosstalk group, i.e., during t1. The decision wether crosstalk is canceled or accepted may be based on a crosstalk strength indicator. The crosstalk strength indicator could be measured in an early training phase of the data transmission system.

The scenario of FIG. 7 may be implemented by providing two bit loading and gain tables for the short lines and three bit loading and gain tables for the long lines. This may result in a slightly increased memory requirement. For the long lines, crosstalk can still be canceled during all time intervals t1, t2, t3. A change of the transmission time of the individual groups, i.e., a reconfiguration of the time intervals t1, t2, t3, can be done in very short time. Therefore, the resources can be allocated in a very flexible way, which may help to achieve high peak rates.

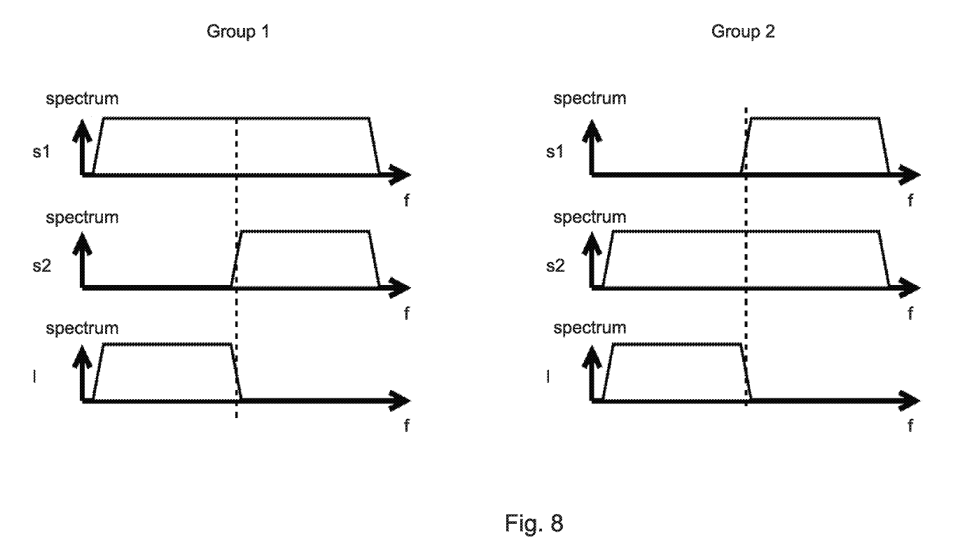

According to some embodiments, crosstalk avoidance may be performed in both the time domain and the frequency domain. For example, the fact that long lines cannot utilize high frequencies may be used to reduce complexity. The vector groups may be arranged such that all lines, both short and long, transmit in the same group, but the short lines use only the higher frequencies while the long lines use only the lower frequencies. An exemplary scenario involving such combination of crosstalk avoidance in time and frequency is illustrated in FIG. 8. In particular, FIG. 8 shows a possible allocation for time and frequency resources for crosstalk avoidance in time and frequency. Group 1 and group 2 are transmitted for a certain portion of the TDD frame, such that crosstalk between the short lines at low frequencies is avoided.

At high frequencies crosstalk from the short lines into long lines does not need to be canceled, because long lines cannot use the higher frequencies. Therefore, the short lines can remain enabled for all time at the higher frequencies where none of the long lines transmits, while the overall size of the vectored group is still the same.

This method of crosstalk avoidance in time and frequency may be implemented without impact on the performance of long lines, as the long lines cannot use the higher frequencies, anyway. A switch frequency where the short lines remain active may be selected in such a way that it is higher than the highest frequency used by the long lines.

According to a further embodiment, some lines may be used in low-power mode, in which the required bit rate is very low. These lines could use only a small number of tones, predominantly allocated at low frequencies to avoid PSD (Power Spectral Density) normalization issues related to discontinuous operation.

According to an embodiment, channel estimation in large vectoring groups, e.g., in the groups of short lines and the group of long lines, may be performed as follows: Similar to typical wireline MIMO systems, estimation of the crosstalk channel characteristics may be done based on orthogonal codes. One code may be assigned to each line, such that the codes of the lines are orthogonal to each other. The codes can be constructed of the values +1, −1 and 0. The length of the code may depend on the number of lines. Longer codes are required for larger systems, i.e., higher numbers of lines. On the other hand, very large codes can slow down the channel estimation process. In view of this situation, the codes may be arranged according to the discontinuous operation groups. Then, the lines of the short line groups may use the same code, because no channel estimation between them is required. That is to say, in the above examples, the lines of the group of short lines s1 may use the same codes as the lines of the group of short lines s2.

The following example shows how the codes may be constructed. In this example, construction of the code with two short codes c_{i,j} and zero symbols is assumed.

$$\begin{matrix}short 1 & {c}_{1 , 1} & {c}_{1 , 2} & {c}_{1 , 3} & {c}_{1 , 4} & 0 & 0 & 0 & 0 \\ short 2 = & 0 & 0 & 0 & 0 & {c}_{1 , 1} & {c}_{1 , 2} & {c}_{1 , 3} & {c}_{1 , 4} \\ long & {c}_{2 , 1} & {c}_{2 , 2} & {c}_{2 , 3} & {c}_{2 , 4} & {c}_{2 , 1} & {c}_{2 , 2} & {c}_{2 , 3} & {c}_{2 , 4}\end{matrix} \qquad ( 18 )$$

The individual non-zero sections of the estimation codes are shorter with this configuration. The full channel estimation can therefore be available in shorter time.

In some embodiments, line joining with orthogonal vectoring groups may be used. According to these embodiments, the crosstalk avoidance method shall also be applied to a training sequence, e.g., as used when joining a line to the data transmission system. To categorize the line into one of the groups (one of the groups of short lines or the group of long lines), an estimation of the line length (e.g., electrical length in terms of signal attenuation) may be required. The line length estimation can be performed at an early stage of initialization. However, crosstalk cancelation in downstream direction from the joining line into all active lines may be needed in advance to this stage because for length estimation some feedback signal is required. To configure the feedback signal, some configuration data may need to be transmitted in the downstream direction.

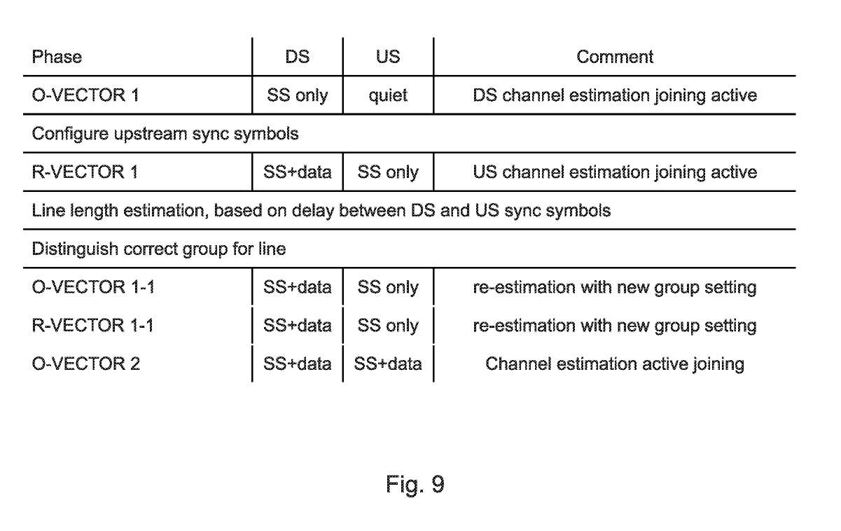

FIG. 9 shows a table including relevant steps of an initialization sequence for a G.fast line. These steps may be performed as a startup or training sequence for joining a new line into a system of active lines. For the first steps of the initialization sequence, O-VECTOR 1, the new lines are put into the groups arbitrary. After R-VECTOR 1, the line length is known and it is possible to select the right group for each of the new lines.

The additional steps within the initialization sequence allow for crosstalk avoidance during the initialization sequence and help putting the joining line into the right group.

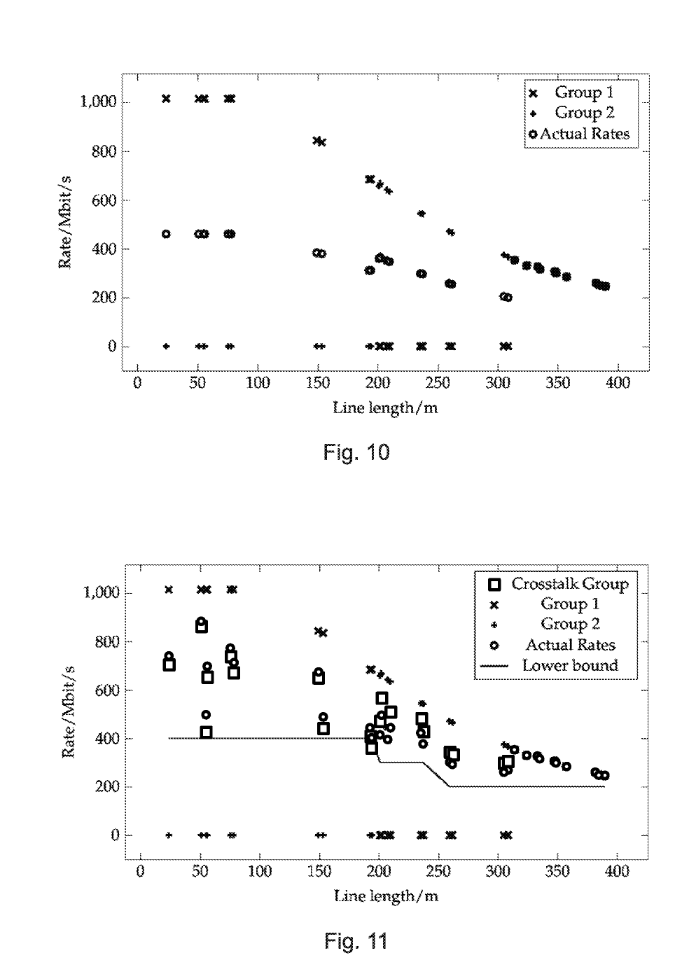

In the following, simulation results will be presented for further illustrating effects of the above methods. The simulation results demonstrate the methods on a G.fast system with 30 lines that are distributed along a cable bundle with 400 m length. FIG. 10 shows the data rates of the individual lines of the binder. There are two groups of lines, one with the 10 shortest and 10 long loops and the other one with the 20 longest lines. The 10 longest lines are part of both groups, group 1 and group 2. Therefore, each individual group has 20 lines while there are 30 lines in total.

When one of the groups uses the full transmit time, the rates marked “Group 1” and “Group 2” are achieved. The guaranteed rates with all lines active and a minimum rate of 200 Mbit/s are shown with the label “Actual Rates”. These rates are achieved when both, group 1 and group 2 are active for a certain time of the frame.

FIG. 11 shows simulation results representing data rates for the case when the additional crosstalk group is allowed (as explained in connection with FIG. 7). Accordingly, the simulation results of FIG. 11 are based on a scenario with three groups and a crosstalk configuration, where all lines transmit, but the crosstalk between the short lines is only partially canceled. When the system is configured to transmit in the “Crosstalk Group”-configuration all time, the data rates marked in black are achieved. Group 1 and group 2 are selected the same way as in the scenario of FIG. 10. This example shows that in some cases, allowing uncanceled crosstalk can increase average data rates of the binder. It is noted that in scenarios with high crosstalk, the crosstalk group typically achieves very low rates and thus cannot be used to achieve the target rates.

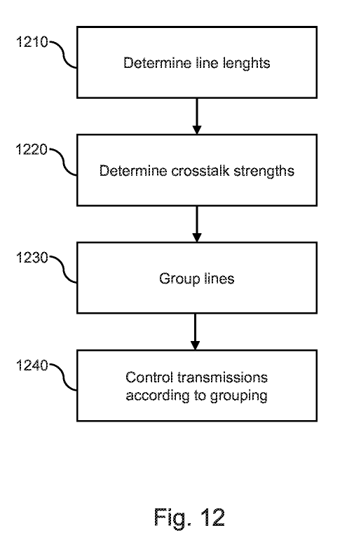

FIG. 12 shows a flowchart illustrating a method according to embodiments, which may be utilized to implement concepts as explained above. The method may be applied for of crosstalk avoidance in a data transmission system, e.g., including a DP and a group of CPEs connected to the DP by a bundle (or binder) of lines, such as illustrated in FIG. 1, FIG. 2A, FIG. 2B, FIG. 3, FIG. 4, or FIG. 5. The lines may for example each correspond to a pair of copper lines. The data transmission system may for example be based on a Vectoring DSL technology, such as G.fast.

While the method of FIG. 12 is described as a series of steps, acts or events, the order in which such steps, acts or events are described is not to be construed as limiting. Instead, in other embodiments the acts or events may be performed in a different order, and/or some of the acts or events may be performed in parallel, for example by different devices in a system or by different parts of a circuit. The method of FIG. 12 may for example be implemented by a device of a data transmission system, e.g., by the provider equipment 10 of FIG. 1, by the DP or street cabinet 200 as illustrated in FIG. 2A, by one or both distributed DPs 201, 202 of FIG. 2B, or by the DPs or DP processors 401, 402, 403 of FIG. 4. Accordingly, the method may be performed by one or more DPs of a FTTC or FTTB Vectoring DSL system, or by one or more processors of such DP.

At 1210, line lengths may be determined the lines of the data transmission system. For at least some of the lines, this may be accomplished during a training or startup sequence for joining the given line to the data transmission system, e.g., as explained in connection with FIG. 9. However, it is also possible to perform this determination simultaneously for larger sets of the lines, e.g., at initialization of the complete data transmission system.

At 1220, crosstalk strengths may be determined for the lines of the data transmission system. For at least some of the lines, this may be accomplished during a training or startup sequence for joining the given line to the data transmission system, e.g., as explained in connection with FIG. 9. However, it is also possible to perform this determination simultaneously for larger sets of the lines, e.g., at initialization of the complete data transmission system.

At 1230, the lines are grouped into at least three groups. In particular, this may involve separating the lines of the data transmission system at least into a first group, a second group, and a third group. This may be based on the line lengths determined at 1210 and/or on the crosstalk strengths determined at 1220. For example, the grouping may be performed in such a way that the lines of the third group have longer line lengths than the lines of the first group and the lines of the second group, i.e., the lines may be grouped into at least one group of long lines and at least two groups of short lines.

At 1240, transmissions on the lines are controlled according to the grouping. In particular, transmissions on lines of the first group may be controlled to occur at different times than transmissions on lines of the second group. Further, some transmissions on lines of the third group may be controlled to occur at the same time with transmissions on the lines of the first group, and some transmissions on the lines of the third group may be controlled to occur at the same time with transmissions on the lines of the second group. Accordingly, the lines of the third group are allowed to transmit simultaneously with the lines of either of the first group and the second group.

The control of transmissions may involve configuring at least a first time interval and a second time interval which does not overlap the first time interval. Transmissions on the lines of the first group may then be assigned to the first time interval while transmissions on the lines of the second group are assigned to the second time interval. For the lines of the third group, some transmissions are assigned to the first time interval and some transmissions are assigned to the second time interval. Examples of a corresponding timing are shown in FIG. 6 (where t1 and t2 correspond to the first time interval and second time interval, respectively) and in FIG. 7 (where t2 and t3 correspond to the first time interval and second time interval, respectively.

The lines of the first group may be discontinued in the second time interval, and the lines of the second group may be discontinued in the first time interval. Discontinuing the line may involve at least switching off a transmit signal supplied to a transmitter connected to the line. However, in some cases the transmitter and crosstalk cancelation coefficients into other active lines may remain active and be used for enhancing received signal power of one or more lines of the third group. A corresponding example is explained in connection with FIG. 5.

In some scenarios, frequencies may be assigned to at least some lines of the first group and/or of the second group which are different from frequencies assigned to the lines of the third group. For example, if the lines are grouped into long lines and short lines, the frequencies assigned to the lines of the first group and/or of the second group may be higher than the frequencies assigned to the lines of the third group. An example of a corresponding utilization of frequency assignments is explained in connection with FIG. 8.

A first crosstalk cancelation group and a second crosstalk cancelation group may be configured, e.g., corresponding to the above-mentioned groups [symbol] ₁ and [symbol] ₂. Such crosstalk cancelation groups are herein also referred to as “vectored group” or “vectoring group”. The first crosstalk cancelation group includes the lines of the first group and the lines of the third group. The second crosstalk cancelation group includes the lines of the second group and the lines of the third group. To reduce compute complexity and memory requirement, crosstalk cancelation may be limited to consideration of lines of the same crosstalk cancelation group. In some scenarios, it is also possible to ignore mutual crosstalk couplings for some lines of the first group and/or for some lines of the second group, i.e., to perform partial crosstalk cancelation within the crosstalk cancelation group.

In some scenarios, the grouping of the lines may also involve separating the lines into the first group, the second group, the third group, and a fourth group, and not subjecting the lines of the fourth group to crosstalk cancelation. A corresponding example is explained in connection with FIG. 7, where the crosstalk group corresponds to the fourth group.

Assigning of lines to the fourth group may be accomplished depending on the crosstalk strength indicator determined at 1220.

In some scenarios, efficiency of channel estimation may be improved by constructing codes for channel estimation which are the same for the lines of the first group and the lines of the second group.

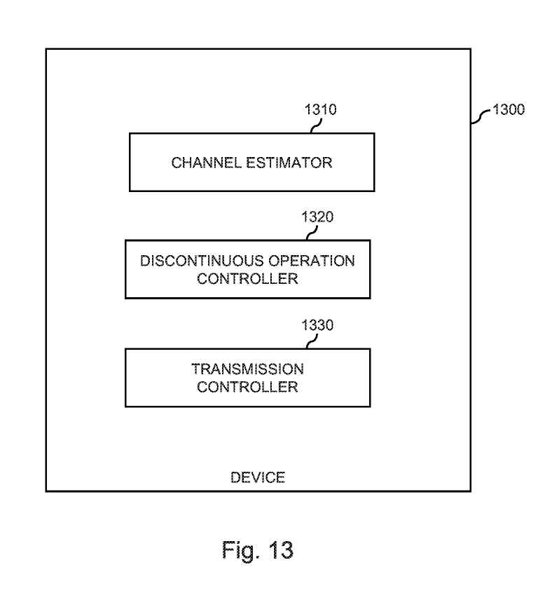

FIG. 13 schematically illustrates a device 1300 according to an embodiment. The device 1300 of FIG. 13 may for example correspond to the provider equipment 10 of FIG. 1. In particular, the device of FIG. 13 may correspond to a DP of an FTTdp system, a DP of a FTTC system, or a DP of an FTTB system or a processor of such DP.

The device 1300 may be configured to perform the method as explained in connection with FIG. 12. For example, the device 1300 may be equipped with one or more processors configured to perform or control the steps, acts, or events of the method of FIG. 12. For this purpose, the processors may execute correspondingly configured program code, which may be stored in a memory of the device 1300. The processor(s) may thus implement functional elements of the device 1300 as illustrated in FIG. 13. However, it is to be understood that the functional elements of FIG. 13 could also be implemented in other ways, e.g., using dedicated hardware circuitry or a combination of dedicated hardware circuitry and software.

As illustrated, the device 1300 may be provided with a grouping controller 1310. The grouping controller 1310 may in particular implement the above-mentioned separation of lines into groups or configuration of crosstalk cancelation groups.

As further illustrated, the device 1300 may be provided with a discontinuous operation controller 1320. The discontinuous operation controller 1320 may implement functionalities relating to the utilization of discontinuous operation on certain lines of the data transmission system, e.g., by controlling when and which lines to discontinue.

As further illustrated, the device 1300 may be provided with a transmission controller 1330. The transmission controller 1330 may implement the above-mentioned functionalities relating to controlling the transmissions on the lines according to the determined grouping, e.g., by determining when and on which frequencies to transmit and/or by controlling utilization of crosstalk cancelation.

Accordingly, embodiments as described herein may involve crosstalk avoidance using discontinuous operation, where the lines are separated into at least three groups. Some of the groups transmit all time while other groups perform crosstalk avoidance and do never transmit at the same time. Further, embodiments as described herein may involve efficient channel estimation for larger groups of lines. Further, embodiments as described herein may involve grouping of the lines with respect to the line length. Further, embodiments as described herein may involve combination of partial crosstalk cancelation and crosstalk avoidance by discontinuous operation. Further, embodiments as described herein may involve combination of crosstalk avoidance in time and crosstalk avoidance in frequency. Further, embodiments as described herein may involve performance enhancement for long lines by discontinuing short lines. Further, embodiments as described herein may involve an extended start-up sequence, including an additional stage of line length estimation and assigning the line into appropriate group.

The above-described embodiments serve as examples only and are not to be construed as limiting. The above-mentioned methods may be implemented in devices using hardware, software, firmware or combinations thereof, for example in the devices and systems illustrated in FIG. 1, FIG. 2A, FIG. 2B, FIG. 4, or FIG. 5. For example, to implement methods disclosed herein firmware of conventional devices may be updated to be able to use techniques disclosed herein.

1-23. (canceled)

24. A method for crosstalk avoidance in a data transmission system, the method comprising:
separating lines of the data transmission system at least into a first group, a second group, and a third group;
controlling transmissions on lines of the first group to occur at different times than transmissions on lines of the second group;
controlling transmissions on lines of the third group to occur at the same time with transmissions on the lines of the first group; and
controlling transmissions on the lines of the third group to occur at the same time with transmissions on the lines of the second group.

25. The method according to claim 24, comprising:
configuring at least a first time interval and a second time interval which does not overlap the first time interval;
assigning transmissions on the lines of the first group to the first time interval;
assigning transmissions on the lines of the second group to the second time interval;
assigning transmissions on the lines of the third group to the first time interval; and
assigning transmissions on the lines of the third group to the second time interval.

26. The method according to claim 25, comprising:
discontinuing the lines of the first group in the second time interval; and
discontinuing the lines of the second group in the first time interval.

27. The method according to claim 26, comprising:
controlling a transmitter and crosstalk cancelation coefficients of a discontinued line for enhancing received signal power of one or more lines of the third group.

28. The method according to claim 24, comprising:
for each of the lines, determining a line length; and
according to the determined line lengths, separating the lines into the first group, the second group, and the third group.

29. The method according to claim 28, comprising:
estimating the line length during a startup sequence for joining the line to the data transmission system; and
depending on the estimated line length, assign the line to the first group, the second group, or the third group.

30. The method according to claim 28,
wherein the lines of the third group have longer line lengths than the lines of the first group and the lines of the second group.

31. The method according to claim 24, comprising:
assigning frequencies to at least some lines of the first group and/or of the second group which are different from frequencies assigned to the lines of the third group.

32. The method according to claim 30, comprising:
assigning frequencies to at least some lines of the first group and/or of the second group which are higher than frequencies assigned to the lines of the third group.

33. The method according to claim 24, comprising:
configuring a first crosstalk cancelation group comprising the lines of the first group and the lines of the third group;
configuring a second crosstalk cancelation group comprising the lines of the second group and the lines of the third group;
wherein crosstalk cancelation is limited to consideration of lines of the same crosstalk cancelation group.

34. The method according to claim 33, comprising:
in crosstalk cancelation, ignoring mutual crosstalk couplings for some lines of the first group and/or for some lines of the second group.

35. The method according to claim 24, comprising:
separating the lines into the first group, the second group, the third group, and a fourth group, wherein the lines of the fourth group are not subject to crosstalk cancelation.

36. The method according to claim 35, comprising:
for each of the lines, estimating a crosstalk strength indicator; and
depending on the crosstalk strength indicator, assigning some of the lines to the fourth group.

37. The method according to claim 24, comprising:
constructing codes for channel estimation which are the same for the lines of the first group and the lines of the second group.

38. The method according to claim 24,
wherein the data transmission system is based on a Vectoring Digital Subscriber Line technology.

39. A device for a data transmission system, the device comprising at least one processor configured to:
separate lines of the data transmission system at least into a first group, a second group, and a third group;
control transmissions on lines of the first group to occur at different times than transmissions on lines of the second group;
control transmissions on lines of the third group to occur at the same time with transmissions on the lines of the first group; and
control transmissions on the lines of the third group to occur at the same time with transmissions on the lines of the second group.

40. The device according to claim 39, wherein the at least one processor is configured to:
for each of the lines, determine a line length; and
according to the determined line lengths, separate the lines into the first group, the second group, and the third group.

41. The device according to claim 39, wherein the at least one processor is configured to:
estimate the line length during a startup sequence for joining the line to the data transmission system; and
depending on the estimated line length, assign the line to the first group, the second group, or the third group.

42. The device according to claim 39,
wherein the lines of the third group have longer line lengths than the lines of the first group and the lines of the second group.

43. The device according to claim 42, wherein the at least one processor is configured to:
assign frequencies to at least some lines of the first group and/or of the second group which are higher than frequencies assigned to the lines of the third group.

44. A data transmission system, comprising:
a plurality of lines; and
at least one device configured to:
separate lines of the data transmission system at least into a first group, a second group, and a third group;
control transmissions on lines of the first group to occur at different times than transmissions on lines of the second group;
control transmissions on lines of the third group to occur at the same time with transmissions on the lines of the first group; and
control transmissions on the lines of the third group to occur at the same time with transmissions on the lines of the second group.

45. The data transmission system according to claim 44,
wherein the at least one device is a distribution point of a fibre to the curb or fibre to the building system based on a Vectoring Digital Subscriber Line technology.

46. The data transmission system according to claim 44,
wherein the at least one device is a processor of a distribution point of a fibre to the curb or fibre to the building system based on a Vectoring Digital Subscriber Line technology.

47. The device according to claim 39,
wherein the device is a processor of a distribution point of a fiber to the curb or fiber to building system based on a Vectoring Digital Subscriber Line technology.
